(19) United States
(12) Patent Application Publication
(10) Pub. No.: US 2013/0286452 A1
(43) Pub. Date: Oct. 31, 2013

(54) CONTAINER WITH DIFFUSE REFLECTION IN A TRANSITION AREA

(71) Applicant: Jean-Francois Hugonnet, La Conversion-Lutry (CH)

(72) Inventor: Jean-Francois Hugonnet, La Conversion-Lutry (CH)

(73) Assignee: PHILIP MORRIS PRODUCTS S.A., Neuchatel (CH)

(21) Appl. No.: 13/459,751

(22) Filed: Apr. 30, 2012

(51) Int. Cl. G02B 5/32; F21V 9/06; B05D 5/06; G02B 5/02

(52) U.S. Cl. 359/15; 359/599; 359/359; 427/162

(57) ABSTRACT

The present invention relates to a container comprising a multilayer sheet, the multilayer sheet comprising a substrate layer with an optical element being formed by a reflective microstructure, and a print layer comprising add-on material. The multilayer sheet further comprises a first area, wherein the optical element is provided, and a second area, wherein add-on material is provided and wherein no microstructure is provided, and a transition area between the first area and the second area. The transition area comprises a transition microstructure that is formed in the substrate layer, wherein the transition microstructure provides for a substantial diffuse reflection of light. The invention further relates to a method for production of a multilayer sheet with an optical element.

The present invention relates to a container comprising a multilayer sheet, the multilayer sheet comprising an optical element. The invention further relates to a blank for such a container, and a method for the production of such a multilayer sheet.

In the prior art, multilayer sheets for containers are known. A multilayer sheet may be, for example, a blank for a container.

Optical elements that can be used for design or marketing purposes are known in the prior art and are used, for example, to attract the attention of consumers or to verify the origin of a product. Refractive or diffractive optical elements, such as Fresnel lenses and holographic elements are described for example in U.S. Pat. No. 7,298,533. These elements may be formed by microstructures that create a desired optical effect by means of refraction, diffraction or combinations of refraction and diffraction. Such microstructures may be made reflective by metallization where the metallization is not limited only to the area of the microstructures, but also extends into neighboring areas.

It is a known problem that the steps of production of the manufacturing process of such optical elements and steps of the application of print need to occur at different locations. Therefore, achieving alignment of the optical element with the print is difficult and expensive. A misalignment between the print and the optical element is typically visible to the consumer. This is because, at the border of the optical element, there is no microstructure, such that the reflective surface is flat and, thus, has a reflective appearance that is unattainable by print. For example in case of misalignment in particular of a round optical element with its surrounding print, a crescent shaped shiny surface will be visible in the printed product.

The object of the invention is to provide a container comprising an optical element that provides the container with an excellent visual appearance that avoids the disadvantages of the prior art.

According to the invention there is provided a container comprising a multilayer sheet. The multilayer sheet comprises a substrate layer and a print layer. The substrate layer further comprises an optical element formed by a reflective microstructure. The print layer comprises add-on material. The multilayer sheet comprises a first area on its surface, where the reflective microstructure is provided, and a second area on its surface, where add-on material is provided but where no microstructure is provided. A transition area between the first area and the second area is provided and comprises a transition microstructure that is formed in the substrate layer of the multilayer structure. The transition microstructure provides for a substantially diffuse reflection of light. This means that, particularly for multilayered structures, the reflection cannot be entirely diffuse, but contains at least a small amount of specular reflection. This is unavoidable due to intrinsic specular reflection on layer transitions between flat layers above the layer with the microstructure. Preferably the microstructure provides a substantially diffuse reflection.

The term “specular reflection” is used throughout the specification to refer to a reflection in which light from a single incoming direction is reflected into a single outgoing direction. Thus, a surface that exhibits specular reflection appears to be glossy.

The term “diffuse reflection” is used throughout the specification to refer to a reflection in which incoming light from a single incoming direction is reflected in several directions. Thus, a surface that exhibits diffuse reflection appears to be matt.

In the known prior art, a specular reflection in the transition area would be apparent, such that the transition area has to be coated with a matt varnish to cover the otherwise visible and undesired reflection. Preferably, the diffuse reflection in the transition area has a similar appearance to the diffuse reflection of preferred varnishes and colors that are used to print the multilayer sheet. Thus, a misalignment between the first area bearing the optical element, and the second layer bearing the add-on material will be minimized.

According to the invention, the requirement of the alignment of the print and the optical element is reduced and but at the same time a high quality end product is obtained. Advantageously, the cost of the production process of the multilayer sheet is not substantially increased, as the formation of the microstructure in the first area and the microstructure in the transition area can be carried out in one step and with one tool. In other embodiments, the formation of the microstructure in the first area and the microstructure in the transition area can be carried out with two individual tools that are in registration with each other.

One way to obtain the diffuse reflection in the transition area is to provide a stochastically formed microstructure, as for example obtained by a sandblasted tool surface or by providing a grating.

In some embodiments, other parts of the multilayer sheet may also be designed to have a matt appearance by forming a diffusely reflective microstructure in these other parts, such that a diffuse reflection of light is obtained.

A diffuse reflection may be provided by forming the microstructure as a rough or irregular microstructure in the surface layer. Such an irregularly formed microstructure may be created by a tool with a sandblasted surface. Alternatively, a diffuse reflection can be obtained if the neighboring peaks of a regular microstructure are at a distance from each other that is shorter that than the wave length of visible light. This leads to a diffraction of the incoming light to create a diffuse reflection. The peaks of such a regular surface may be in the form of a pyramidal or saw tooth profile. Such a microstructure may be created by grating.

In particular, the reflection provided in the transition area may be achromatic, thus providing substantially the same reflection for light of all wavelengths, such that no color effect is created by the reflection. In other embodiments, the optical element may at least partially provide a different reflection for different wavelengths of light to create a color effect.

Generally, the optical element may be a diffractive or refractive optical element or a combination of a diffractive and refractive optical element. The transition area may have diffractive or refractive properties or a combination of diffractive and refractive properties as well.

For the avoidance of doubt, the first area, the transition area and the second area are differentiated by the presence or absence of a microstructure in the substrate layer. For the avoidance of doubt, all areas of the container may comprise add-on material. That is, all areas of the container may be printed. It is preferred that the print fades out in the transition area, such that the first area is not printed in order to improve the visibility of the optical element.

The substrate may comprise two layers, namely, a base layer and an imprinting layer for creating the microstructure. An example of a suitable base layer is a polyethylene terephthalate (PET) layer. An example of a suitable imprinting layer is a heat curable or ultraviolet light (UV) curable layer.

The microstructures may be provided in an ultra-violet curable coating. Typically, in such a case, the microstructures are formed in the ultra-violet curable coating before curing.

The ultra-violet curable coating may be colored to provide a color effect in the reflected light. This provides the benefit that the optical element or transition area can appear in desired colors.

Alternatively to providing the microstructure in a ultra-violet curable coating the microstructures may be provided directly on the substrate layer by embossing.

The add-on material in the print layer may comprise ink, lacquer, varnish, metallisation, luminescent material and combinations thereof, and any other materials that may alter the feel, odour or appearance of the container.

The terms “front”, “back”, “upper”, “lower”, “side”, “top”, “bottom” and other terms used to describe relative positions of the components of containers according to the invention refer to the container in an upright position with the lid (where present) at the top end and the hinge (where present) on the back. The terms “left” and “right” are used with reference to side walls of the container when the container is viewed from the front in its upright position. When the container in the upright position is open, the consumer articles contained in the box may be removed from the upper end of the container. The term “longitudinal” refers to a direction from bottom to top or vice versa. The term “transverse” refers to a direction perpendicular to the longitudinal direction across the front wall, the back wall or one of the side walls.

In a preferred embodiment, the fraction in between the intensity of a specularly reflected beam from the microstructure in the transition area and the intensity of the light subjected to the transition area is less than about 0.5. Preferably, this fraction is less than 0.1, and more preferably less than 0.05. Preferably, the fraction of the intensity between the specularly reflected beam and an incoming unpolarized light beam with parallel light rays subjected to the microstructure in the transition area is less than about 0.5. Preferably, this fraction is less than 0.1, and more preferably less than 0.05. In some embodiments, a certain percentage of specular reflection is desired, in particular when the add-on material used on the container is not completely matte, but is slightly glossy.

In one embodiment, the print layer is provided on a first side of the multilayer sheet, while the microstructures are formed on the side of the substrate layer that faces away from the first side. This feature provides the benefit that the add-on material interferes less with the microstructures. Preferably, a base board is provided on a second side of the multilayer sheet, wherein the second side is opposite of the first side of the multilayer sheet. In particular, the base board is fixed to the substrate, and serves the purpose of providing stability to the multilayer sheet. In some embodiments, the base board may be a cardboard sheet. In other embodiments, the baseboard may be a polymer sheet.

The optical element may comprise an area providing a Fresnel lens outside of the transition area. The microstructure pattern forming the Fresnel lens is reflective, such that the lens effect will be applied to the reflected image. Preferably, the optical element occupies a circular area, while the transition area occupies an annular area bordering on the Fresnel lens. Alternatively, the area of the optical element has a shape that is different from a circle. Examples of suitable shapes include regular and irregular shapes. Suitable regular shapes include a rectangle, a triangle and an oval. Suitable irregular shapes include those defined by, for instance, text or icons or any other irregular shape. In the case of shapes other than a circle, the transition area preferably defines a perimeter having a thickness of between about 0.2 mm and about 3 mm bordering on the area of the optical element.

In other embodiments, the optical element comprises an area providing a holographic element outside of the transition area. A holographic element is desirable for reproducing the appearance of a three dimensional object by providing a defined refractive microstructure in the substrate.

Preferably, the substrate layer is translucent, particularly for light in the visual range to the human eye, that is, light with a wavelength of between about 380 nm to about 740 nm. However, the optical element may also be designed to be used for infrared or ultra-violet light, such that the translucence may also apply for those wavelengths.

The substrate layer is preferably a polymer film. More preferably it is a PET film. However, in some embodiments, wherein the microstructure is provided on the same side as the add-on material, namely the side facing the outside of the container, the substrate layer may be substantially opaque. Preferably, a substantially transparent covering layer may be provided on the substrate layer to protect the microstructure and to provide a surface for applying the add-on material or a primer or both.

The base layer of the transparent substrate layer may be colored to provide a colored effect on the reflected light in embodiments with the microstructure directly provided in the base layer.

Preferably, the microstructure is covered with a reflective layer. The reflective layer is preferably a coating and, more preferably, a metallization.

Preferably, a substantially Lambertian reflection is obtained by the microstructure in the transition area. A Lambertian reflection is a diffuse reflection, wherein reflected light is scattered into the hemisphere above the surface with the radiant power being substantially the same for all directions. In particular, it is an isotropic directional distribution of light by means of reflection.

Light falling on a surface with Lambertian reflection is scattered such that the apparent brightness of the surface to an observer is substantially the same, regardless of the observers angle of view.

The invention also relates to a container that is printed in the second area and, at least partially, in the transition area. Such a container exhibits the benefit of showing an excellent visual appearance, while not requiring a low tolerance regarding the alignment of the add-on material and the optical element. Thus, it requires a less precise registration of the tool forming the optical element and the printing tool.

Preferably, the container comprises an inner frame mounted within the box, wherein the inner frame extends above the upper edges of at least the front wall of the box of the container. The inner frame is therefore visible to the consumer when the lid is opened. The front wall of the inner frame may be printed with indicia which may be the same as, or different to the indicia printed on the front wall of the box. Alternatively, or in addition, the front wall of the inner frame may be cut into a distinctive shape, for example, to reflect the branding of the consumer goods.

Preferably, the front wall of the inner frame is provided with a cut out portion at an upper edge of the inner frame. This provides a more convenient access to the consumer goods within the container, without significantly reducing the surface area of the front wall of the inner frame.

Alternatively, or in addition to an inner frame, the consumer goods within the container may be wrapped with an inner liner, which is visible above the upper edge of the front wall of the box and the front wall of the inner frame (if present) when the container is open.

A container according to the invention may be in the shape of a rectangular parallelepiped, with right-angled longitudinal and right-angled transverse edges. Alternatively, the container may comprise one or more rounded longitudinal edges, rounded transverse edges, bevelled longitudinal edges or bevelled transverse edges, or combinations thereof. For example, the container according to the invention may comprise, without limitation:

One or two longitudinal rounded or bevelled edges on the front wall, and/or

One or two longitudinal rounded or bevelled edges on the back wall.

One or two transverse rounded or bevelled edges on the front wall, and/or

One or two transverse rounded or bevelled edges on the back wall.

One longitudinal rounded edge and one longitudinal bevelled edge on the front wall, and/or

One transverse rounded edge and one transverse bevelled edge on the back wall.

One or two transverse rounded or bevelled edges on the front wall and one or two longitudinal rounded or bevelled edges on the front wall.

Two longitudinal rounded or bevelled edges on a first side wall or two transverse rounded or bevelled edges on the second side wall.

Where the container comprises one or more rounded edges and is made from a laminar blank, the blank preferably comprises three, four, five, six or seven scoring lines or creasing lines to form the rounded edge in the assembled container. The scoring lines or creasing lines may be either on the inside of the container or on the outside of the container. Preferably, the scoring lines or creasing lines are spaced apart from each other at a distance of between about 0.3 mm and about 4 mm.

Preferably, the spacing of the creasing lines or scoring lines is related to the thickness of the laminar blank. Preferably, the spacing between the creasing lines or scoring lines is between about 0.5 and about 4 times larger than the thickness of the laminar blank.

Where the container comprises one or more bevelled edges, the one or more bevelled edges preferably have a width of between about 1 mm and about 10 mm, more preferably between about 2 and about 6 mm. Alternatively, the container may comprise a double bevel formed by three parallel creasing lines or scoring lines that are spaced apart such that two distinct bevels form the edge of the container.

For a container having a rectangular transverse cross section, the container may have, for example, a polygonal cross section such as a triangular, quadrangular or hexagonal cross section, or a cross section which is oval, semi-oval, circular or semi-circular.

Where the container comprises a bevelled edge and is made from a laminar blank, the bevel may be formed by two parallel creasing lines or scoring lines in the laminar blank. The creasing lines or scoring lines may be arranged symmetrically to the edge between a first wall and a second wall. Alternatively, the creasing lines or scoring lines may be arranged asymmetrically to the edge between the first wall and the second wall, such that the bevel extends further into the first wall of the container than into the second wall of the container.

The container may be formed from any suitable materials including, but not limited to, cardboard, plastic, metal, or combinations thereof. Preferably, the cardboard has a weight of between about 100 grams per square metre and about 350 grams per square metre.

Containers according to the invention may be used as packages for a variety of consumer goods. In particularly preferred embodiments, containers according to the invention are used to package smoking articles. Preferred smoking articles include, but are not limited to, known lit-end cigarettes, cigars or cigarillos, heated smoking articles comprising a combustible fuel element or heat source and an aerosol-generating substrate (for example cigarettes of the type disclosed in U.S. Pat. No. 4,714,082) and smoking articles for use with electrical smoking systems (for example cigarettes of the type disclosed in U.S. Pat. No. 5,692,525).

Through an appropriate choice of the dimensions thereof, containers according to the invention may be designed to hold different total numbers of smoking articles, or different arrangements of smoking articles. For example, through an appropriate choice of the dimensions thereof, containers according to the invention may be designed to hold a total of between ten and thirty smoking articles.

Containers according to the invention may hold one, two, three four or five separate bundles of consumer goods. The separate bundles may be arranged substantially parallel to the front wall and to the back wall or substantially perpendicular to the front wall and to the back wall.

Within a bundle, the smoking articles may be arranged in different collations, depending on the total number of smoking articles, the dimensions of the smoking articles or the cross sectional shape of the container. For example, the smoking articles may be arranged in a bundle in a single row of five, six, seven, eight, nine or ten. Alternatively, the smoking articles may be arranged in two or more rows. The two or more rows may contain the same number of smoking articles. For example, the smoking articles may be arranged in: two rows of five, six, seven, eight, nine or ten; three rows of five, six, seven, eight, nine, or ten; or four rows of four, five, six or seven. Alternatively, the two or more rows may include at least two rows containing different numbers of smoking articles to each other. For example, the smoking articles may be arranged in: a row of five and a row of six (5-6); a row of six and a row of seven (6-7); a row of seven and a row of eight (7-8); a middle row of five and two outer rows of six (6-5-6); a middle row of five and two outer rows of seven (7-5-7); a middle row of six and two outer rows of five (5-6-5); a middle row of six and two outer rows of seven (7-6-7); a middle row of seven and two outer rows of six (6-7-6); a middle row of nine and two outer rows of eight (8-9-8); or a middle row of six with one outer row of five and one outer row of seven (5-6-7).

Containers according to the present invention may hold smoking articles of the same type or brand, or of different types or brands. In addition, both filterless smoking articles and smoking articles with various filter tips may be contained, as well as smoking articles of differing length (for example, between about 40 mm and about 180 mm), diameter (for example, between about 4 mm and about 9 mm). In addition, the smoking articles may differ in strength of taste, resistance to draw and total particulate matter delivery. Wherein the container comprises more than one bundle, each bundle within the same container may hold the same or different types of smoking articles as listed above.

Preferably, the dimensions of the container are adapted to the length of the smoking articles, and the collation of the smoking articles. Typically, the outer dimensions of the container are between about 0.5 mm to about 5 mm larger than the dimensions of the bundle of smoking articles housed inside the container.

Preferably, containers according to the invention have a height of between about 60 mm and about 150 mm, more preferably a height of between about 70 mm and about 125 mm, wherein the height is measured from the top wall to the bottom wall of the container.

Preferably, containers according to the invention have a width of between about 12 mm and about 150 mm, more preferably a width of between about 70 mm and about 125 mm, wherein the width is measured from the first side wall to the second side wall of the container.

Preferably, containers according to the invention have a depth of between about 6 mm and about 100 mm, more preferably a depth of between about 12 mm and about 25 mm wherein the depth is measured from the front wall to the back wall of the container (comprising the hinge between box and lid).

Preferably, the ratio of the height of the container to the depth of the container is in between about 0.3 to 1 and about 10 to 1, more preferably between about 2 to 1 and about 8 to 1, most preferably between about 3 to 1 and 5 to 1.

Preferably, the ratio of the width of the container to the depth of the container is in between about 1 to 1 and about 10 to 1, more preferably between about 2 to 1 and about 8 to 1, most preferably between about 2 to 1 and 3 to 1.

Preferably, the ratio of the height of the lid back wall to the height of the box back wall is between about 0 to 1 (hinge located at the top edge of the container) to about 1 to 1, more preferably, between about 1 to 5 and about 1 to 10, most preferably, between about 1 to 6 to about 1 to 8.

Preferably, the ratio of the height of the lid front wall to the height of the box front wall is between about 1 to 0 (lid covering the entire front wall) to about 1 to 10, more preferably, between about 1 to 1 and about 1 to 5, most preferably, between about 1 to 2 and about 1 to 3.

Where the inner housing of a container according to the present invention contains one or more bundles of smoking articles, the smoking articles are preferably wrapped in an inner liner of, for example, metal foil or metallised paper.

Where the container comprises smoking articles, the container may further comprise waste-compartments (for example for ash or butts) or other consumer goods, for example matches, lighters, extinguishing means, breath-fresheners or electronics. The other consumer goods may be attached to the outside of the container, contained within the container along with the smoking articles, in a separate compartment of the container or combinations thereof.

Once filled, containers according to the invention may be shrink wrapped or otherwise over wrapped with a transparent polymeric film of, for example, high or low density polyethylene, polypropylene, oriented polypropylene, polyvinylidene chloride, cellulose film, or combinations thereof in a conventional manner. Where containers according to the invention are over wrapped, the over wrapper may include a tear tape. The tear tape is preferably positioned around the container below the lower edge of the front wall of the lid, such that once the tear tape has been removed, the lid is free to be rotated about the hinge line.

The invention also relates to a blank for a container according to the invention that is at least partially printed. Such a blank may comprise several panels that are depending from each other via folding lines, such that the blank can be folded to form a container. In particular, the multilayer sheet may be provided on one or several panels of the blank, or the multilayer sheet may form one several or all panels of the blank. The add-on material is particularly provided in the second area and, at least partially, in the transition area. In particular, the add-on material is applied such that the visual appearance of the add-on material slowly fades out in the transition area.

The invention also provides a method for production of a multilayer sheet with an optical element, comprising the steps of providing a substrate layer and forming a reflective microstructure in the substrate layer in a first area of the multilayer sheet. The method further comprises the steps of forming a transition microstructure in the substrate layer in a transition area of the multilayer sheet and applying a print layer onto the substrate layer by applying add-on material in a second area, such that the transition area is defined between the first area and the second area. According to the invention, the transition microstructure is formed in the transition area such that a diffuse reflection of light is obtained in the transition area.

In particular, the diffuse reflection is obtained by the shape and structure of the microstructure. It is emphasized that the diffuse reflection also relates to a substantially diffuse reflection which comprises a specular reflection as well. The specular reflection may be provided by substantially flat surfaces of layers in the multilayer sheet, in which the microstructure is not provided.

In particular, the imprinting step may comprise using a sandblasted or grated area of an embossing surface for creating the microstructure in the transition area. Thus, a tool comprising a sandblasted or grated area and an area with a microstructure for creating the optical element may be used.

In another embodiment of the method, the imprinting step may comprise using two different tools, one for creating the microstructure forming the optical element, and one for creating the microstructure for providing a diffuse reflection of light in the transition area. In particular, the embossing surface of the tool for creating the microstructure in the transition area may be sandblasted. The two different tools may be arranged next to each other and may be operated subsequently and in registration with each other.

In an embodiment where the substrate layer comprises an ultra-violet curable coating that is imprinted with the microstructure, the microstructure is further deformed, during the curing process, in the transition area. In particular, the ultra-violet curable coating can be subjected to temperature, such that it deforms in a manner to provide the desired diffuse reflection.

The invention will now be further explained with reference to the figures, which exemplify non-limiting embodiments of the invention.

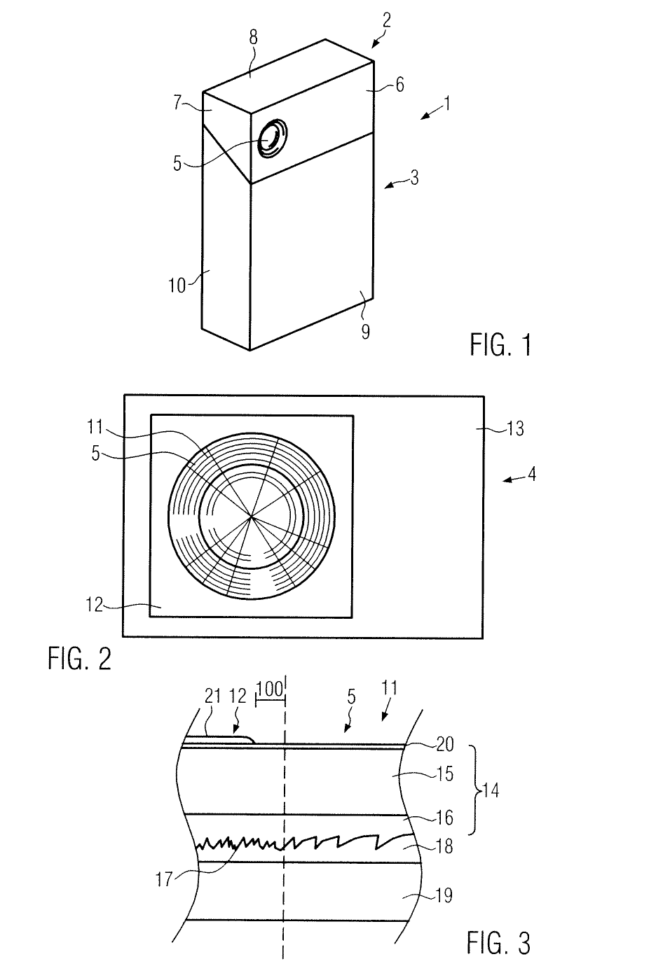

FIG. 1 shows a container comprising a multilayer sheet according to an embodiment of the invention.

FIG. 2 shows a frontal view of the multilayer sheet.

FIG. 3 shows the various layers of the multilayer sheet of the container according to an embodiment of the invention.

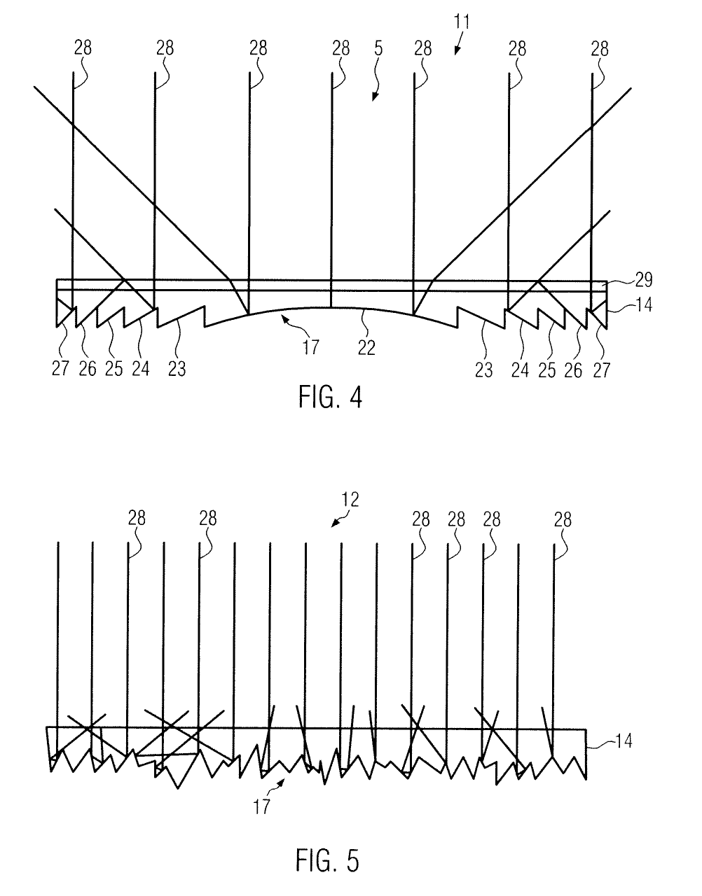

FIG. 4 shows a central part of the microstructure forming the optical element of the multilayer sheet in cross area.

FIG. 5 shows the microstructure of the transition area of the multilayer sheet in cross area.

FIG. 1 shows an embodiment of a container 1 according to the invention. The container 1 comprises a lid 2 that is hingedly connected to a box 3. The container is in the form of a known container for smoking articles, and is folded from one blank comprising several panels. The container 1 comprises an optical element 5, which is provided on the left side of the lid front wall 6. However, the optical element may be provided at any other position on the front wall or on any other wall outside or inside of the container. For example, the optical element may be provided at the lid left wall 7, lid top wall 8, lid right wall, lid rear wall, box front wall 9, box left wall 10, box right wall, box rear wall, and box bottom wall. Furthermore, the optical element 5 may as well be provided inside the lid 2 of the container 1. The surface of the container walls not covered by the optical element 5 is printed and particularly provided with marketing information and a container design. The lid 2 is hingedly connected to the box 3 by means of a hinge line that is arranged between the lid rear wall and the box rear wall.

The term “hinge line” refers to a line about which the lid may be pivoted in order to open the container. A hinge line may be, for example, a fold line or a score line in the back wall of the container. Alternatively, a hinge line may be a fold line or a score line in a piece of material bridging the lower edge of the back wall of the lid and the upper edge of the back wall of the box. Such a piece of material may be, for example, a label that is permanently or removably attached to the back wall of the lid and the back wall of the box. Preferably, the hinge line is positioned along the back wall of the container at a level below the upper edge thereof.

FIG. 2 shows a multilayer sheet 4 that is a subsection of the blank for the container 1. The multilayer sheet 4 has a first area 11 comprising the optical element 5 and a transition area 12 surrounding the first area 11 with the optical element 5. The transition area 12 borders on a second area 13. At least in the first area 11 and the transition area 12 of the multilayer sheet a microstructure is provided in substrate layer 14 (see FIG. 3). The substrate layer 14 can be metallized, such that it is reflective. The microstructure in combination with the metallization provides a specific diffraction or refraction and reflection that enables a special visual perception of the optical element 5 to a consumer. In the embodiment as shown in FIGS. 1 and 2, the optical element 5 is in the form of a Fresnel lens and provides a distorted reflection with a mirror effect. In other embodiments, the optical element 5 may be for example in the form of a holographic element.

As the substrate layer 14 is metallized, at least in the transition area 12, the transition area would provide a mirror effect if no microstructure were to be provided therein. However, where the container 1 is printed with a matt print, the transition area 12 preferably has a matt appearance to prevent a shiny border at the edge of the optical element from being seen in case the print does not fully cover the transition area 12. The print applied to the multilayer sheet 4 is usually provided in the second area 13 and transition area 12 of the multilayer sheet 4. It is beneficial in some embodiments that the print fades out in the transition area 12 towards the optical element 5. It is emphasized that the second area 13 may relate to the whole surface of the container blank, or whole container blank apart from the first area 11 and the transmission area 12, and not only to the small area surrounding the first area 11 as shown in FIG. 2.

In FIG. 3, a partial view of the multilayer sheet 4 is shown in cross section. In particular, the multilayer sheet 4 in the region of the border between the transition area 12 and the first area 11, respectively optical element 5 is shown. The border is indicated as a dashed line. The substrate layer 14 comprises a base layer 15, such as a transparent PET layer, and an ultra-violet curable coating 16 provided at the lower side of the transparent layer. At the lower side of the ultra-violet curable coating 16, a microstructure 17 is provided, which is metallized, such as to reflect light that reaches the microstructure 17 through the base layer 15 and the ultra-violet curable coating 16. In particular, the ultra-violet curable coating 16 is transparent, and may be uncolored, partially colored or fully colored as desired.

The substrate layer 14 is fixed by means of adhesive to a base board 19, which is made of cardboard and provides stability for the multilayer sheet 4 and protection for the microstructure 17.

On a first side, on top of the multilayer sheet 4, a primer 20 is provided to allow the multilayer sheet 4 to be printed. If the primer 20 is provided over the whole of the first side of the multilayer sheet including the optical element 5, it is preferably transparent. However, depending on the lacquer used for the print, the print can also be provided directly on the base layer 15.

As can be seen in FIG. 3, a matt print layer 21 is only provided in the transition area 12, and does not extend over the optical element 5. Depending on the tolerances of registration of the printing tool and the embossing tool, a small tolerance 100 remains between the end of print layer 21 and the border between the optical element 5 and the transition area 12. However, as according to the invention, the microstructure 17 enables a diffuse reflection, no significant differences between the microstructure 17 in the transition area 12 and the matt print layer 21 are seen. Thus, even in case of tolerances regarding the registration of the matt print layer 21 with the optical element 5, a visual border between the matt printing layer 21 and the transition area 12 is not apparent to the consumer.

In FIG. 4, the microstructure 17 in the area of optical element 5 is shown in further detail. The microstructure is comprised of several individual annular surfaces 22, 23, 24, 25, 26, 27, which are concave and concentric and have stepwise discontinuities between them. With respect to each other, the surfaces 22, 23, 24, 25, 26, 27 correspond to the curvature of a complete lens, apart from the discontinuities. Thus, the incoming light beams 28 will be reflected, such that a magnifying effect is obtained.

As can be seen in FIG. 4, the optical element is covered with an optical layer 29, which has refractive properties, such that reflected beams that are below a certain angle with respect to the plane of the optical layer 29, will be partially or fully reflected at the optical layer 29, to improve the optical appearance of the Fresnel lens.

FIG. 5 shows the transition area 12, wherein the microstructure 17 is a stochastically arranged structure. Therefore, parallel incoming light beams 28 will be reflected in all directions, such that a diffuse reflection is obtained. This leads to a matt appearance of the transition area 12 as perceived by a consumer. Apart from an irregular structure as shown in FIG. 5, the matt effect of microstructure 17 in the transition area 12 may also be obtained by a regular structure that has a topography that is of a smaller dimension than the wave length of visible light, such that the light is diffracted in all directions.

In the following, a method for creating the multilayer sheet according to the invention will be explained with reference to FIG. 3. First, a transparent base layer 15 is provided and coated with ultra-violet curable coating 16 at one side of the transparent base layer 15. Then, by means of an embossing tool, a microstructure 17 is created in the ultra-violet curable coating, which provides an optical effect, such as a Fresnel lens or a holographic element. In a transition area 12 bordering on the optical element 5, the microstructure 17 is formed so as to diffusively reflect light. Then, the ultra-violet curable coating is metallized and provided with adhesive 18 for fixing the substrate layer 14, comprising the base layer 15 and the ultra-violet curable coating 16, to a baseboard 19. Finally, a primer 20 is provided on a first side of the multilayer sheet 4 that is opposite of the side of the substrate layer 14 on which the microstructure 17 is provided. Finally, when the multilayer sheet is printed, a print layer 21 is provided on the primer 20, at least in a second area 13 and the transition area 12 of the multilayer sheet 4.

In particular, the multilayer sheet 4 may be a blank for a container 1, and the printed container blank may be folded to form a container for smoking articles.

1. A container comprising a multilayer sheet, the multilayer sheet comprising:
a substrate layer comprising an optical element, the optical element being formed by a reflective microstructure, and
a print layer comprising add-on material,
wherein the multilayer sheet further comprises:
a first area, wherein the optical element is provided, and
a second area, wherein add-on material is provided and wherein no microstructure is provided, and
a transition area between the first area and the second area, the transition area comprising a transition microstructure that is formed in the substrate layer, wherein the transition microstructure provides for a substantial diffuse reflection of light.

2. The container according to claim 1, wherein the fraction of the intensity of a specularly reflected beam from the transition microstructure in the transition area, and the intensity of unpolarized light subjected to the transition microstructure in the transition area to obtain the specularly reflected beam is less than about 0.5.

3. The container according to claim 1, wherein the print layer is provided on a first side of the multilayer sheet, while the microstructures are provided on the side of the substrate layer that is facing away from the print layer.

4. The container according to claim 3, wherein a base board is provided on a second side of the multilayer sheet, wherein the second side is opposite to the first side of the multilayer sheet.

5. The container according to claim 1, wherein the optical element comprises an area providing a Fresnel lens.

6. The container according to claim 1, wherein the optical element comprises an area providing a holographic element.

7. The container according to claim 1, wherein the substrate layer is light transmissive.

8. The container according to claim 1, wherein the substrate layer comprises a ultra-violet curable coating, wherein the reflective microstructure and the transition microstructure are formed within the ultra-violet curable coating

9. The container according to claim 8, wherein the ultra-violet curable coating is colored.

10. The container according to claim 1, wherein the microstructure is provided with a reflective coating.

11. The container according to claim 1, wherein approximately a Lambertian reflection is obtained by the transition microstructure in the transition area.

12. The container according to claim 1, which is at least partially printed in the second area and the transition area.

13. A blank for a container according to claim 1, the blank being the multilayer sheet, which is at least partially printed.

14. A method for production of a multilayer sheet, with an optical element, comprising the steps:
providing a substrate layer, and
forming a reflective microstructure into the substrate layer in a first area of the multilayer sheet,
forming a transition microstructure into the substrate layer in a transition area of the multilayer sheet,
applying a print layer onto the substrate layer by applying add-on material in a second area, such that the transition area is between the first area and the second area, and
wherein in the transition area the transition microstructure is formed such that a diffuse reflection of light is obtained in the transition area.

15. The method according to claim 14, wherein the substrate layer comprises an ultra-violet curable coating in which the microstructures are formed, wherein during the curing process the microstructures are further deformed.
